(19) United States
(12) Patent Application Publication
(10) Pub. No.: US 2026/0365278 A1
(43) Pub. Date: Nov. 19, 2026

(54) STRADDLE-TYPE VEHICLE

(71) Applicant: KAWASAKI MOTORS, LTD., Hyogo (JP)

(72) Inventors: Takeshi NAKAJIMA, Akashi-shi (JP); Tadashi Narumi, Akashi-shi (JP); Koki Nagao, Akashi-shi (JP)

(21) Appl. No.: 19/676,296

(22) Filed: May 13, 2026

(30) Foreign Application Priority Data
May 15, 2025 (JP) 2025-082200

(51) Int. Cl. B62M 7/04; B60L 15/00; B60L 50/60; B62J 43/16

(52) U.S. Cl. CPC B62M 7/04; B60L 15/007; B60L 50/66; B62J 43/16; B60L 2200/12; B60L 2210/10; B60L 2210/40

(57) ABSTRACT

There is provided a straddle-type vehicle including: a vehicle body frame including a head pipe, and a left frame and a right frame extending rearward from the head pipe and forming a pair in a left-right direction; an electric motor that is a traveling drive source; a high-voltage battery configured to output electric power to the electric motor; and a low-voltage battery configured to output electric power having a lower voltage than the high-voltage battery. In a top view of the straddle-type vehicle, the electric motor, the high-voltage battery, and the low-voltage battery are located between the left frame and the right frame. The low-voltage battery is located forward of the high-voltage battery.

### CROSS-REFERENCE TO RELATED APPLICATIONS

This application is based on and claims priority under 35 USC 119 from Japanese Patent Application No. 2025-082200 filed on May 15, 2025, the contents of which are incorporated herein by reference.

### TECHNICAL FIELD

The present disclosure relates to a straddle-type vehicle.

### BACKGROUND ART

JP2010-228661A discloses a scooter-type motorcycle including an electric motor for driving the motorcycle to travel. The motorcycle includes a high-voltage battery that supplies electric power to the electric motor and a low-voltage battery that supplies electric power to the auxiliaries and a control device. The high-voltage battery is disposed below a footrest portion located in front of a seat, and the low-voltage battery is disposed on a right side of a head pipe in a vehicle width direction located in a front portion of the motorcycle.

In JP2010-228661A, electric components such as an electric motor, a DC-DC converter that converts a voltage of the high-voltage battery into a voltage of the low-voltage battery, a conductor box, a power drive unit that converts a direct current into an alternating current, and the control device are located below the seat. For this reason, the plurality of electrical interconnects are disposed between a region forward of a footrest portion and a region rearward of the footrest portion. Therefore, the number of long electrical interconnects is large, and the electrical interconnects become complicated.

### SUMMARY OF INVENTION

The present disclosure provides a straddle-type vehicle that simplifies electrical interconnects.

According to an illustrative aspect of the present disclosure, a straddle-type vehicle includes: a vehicle body frame including a head pipe, and a left frame and a right frame extending rearward from the head pipe and forming a pair in a left-right direction; an electric motor that is a traveling drive source; a high-voltage battery configured to output electric power to the electric motor; and a low-voltage battery configured to output electric power having a lower voltage than the high-voltage battery. In a top view of the straddle-type vehicle, the electric motor, the high-voltage battery, and the low-voltage battery are located between the left frame and the right frame. The low-voltage battery is located forward of the high-voltage battery.

### BRIEF DESCRIPTION OF DRAWINGS

FIG. 1 is a side view illustrating an example of a configuration of a vehicle according to an exemplary embodiment;

FIG. 2 is an enlarged perspective view illustrating a high-voltage battery in FIG. 1 and a periphery thereof;

FIG. 3 is an enlarged right side view of the high-voltage battery in FIG. 1 and the periphery thereof;

FIG. 4 is a perspective view of a cover in FIG. 1 at a closed position as viewed obliquely from above; and

FIG. 5 is a perspective view illustrating a state in which an opening and closing lid of the cover in FIG. 4 is at an open position.

### DESCRIPTION OF EMBODIMENTS

Hereinafter, exemplary embodiments of the present disclosure will be described with reference to the drawings. The embodiments described below each show a comprehensive or specific example. Among the components in the following embodiments, ones not described in the independent claims, which define broadest concepts, will be described as optional components. Each drawing in the accompanying drawings is a schematic diagram and is not necessarily strictly illustrated. In the drawings, substantially the same components are denoted by the same reference numerals, and redundant description may be omitted or simplified.

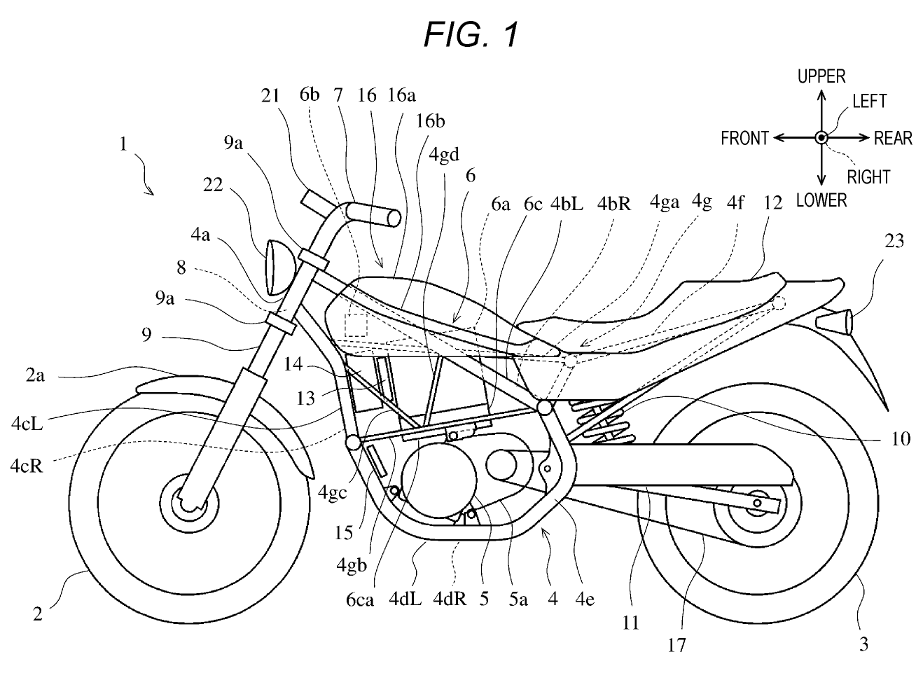

A vehicle 1 according to an exemplary embodiment will be described. FIG. 1 is a side view illustrating an example of a configuration of the vehicle 1 according to the exemplary embodiment. As illustrated in FIG. 1, the vehicle 1 according to the present embodiment is a motorcycle, specifically, a straddle-type vehicle. The straddle-type vehicle is a motorcycle having a structure in which a rider straddles a seat.

In the present specification and claims, an upper direction, a lower direction, a front direction, a rear direction, a left direction, and a right direction are directions based on the vehicle 1 in a state of being disposed upright on the ground extending horizontally. The upper direction refers to a direction from the ground toward the vehicle 1, and the lower direction refers to a direction from the vehicle 1 toward the ground. The front direction refers to a forward direction of the vehicle 1. The rear direction, the left direction, and the right direction indicate corresponding directions with respect to the rider straddling the vehicle 1 standing upright on the ground.

The vehicle 1 includes a front wheel 2, a rear wheel 3, a vehicle body frame 4, an electric motor 5 that generates rotational power, and a battery 6. Further, the vehicle 1 includes handlebars 7, a steering shaft 8, front forks 9 that support the front wheel 2, a rear suspension 10 that supports the rear wheel 3, a swing arm 11, and a seat 12 on which the rider sits in a straddling position. The vehicle 1 further includes an electronic control unit 13, an inverter 14, and a converter 15. Hereinafter, the electronic control unit is also referred to as an "electronic control unit (ECU)". The electric motor 5 drives the rear wheel 3 that is a drive wheel. The vehicle 1 includes a cover 16 that covers the battery 6 mounted on the vehicle 1 from above.

The vehicle body frame 4 includes, as frame elements, a head pipe 4a, a pair of main frames 4bL and 4bR in a left-right direction, a pair of down frames 4cL and 4cR in the left-right direction, a pair of lower frames 4dL and 4dR in the left-right direction, a pivot frame 4e, a seat frame 4f, and a plurality of protective frames 4g. In the vehicle body frame 4, at least parts of the frame elements are joined to each other by welding.

The head pipe 4a is a tubular body having an axis in an upper-lower direction. The main frames 4bL and 4bR extend from an upper portion of the head pipe 4a while inclining downward and rearward. The main frames 4bL and 4bR extend while facing each other in the left-right direction so as to be separated from each other in the left-right direction as being separated from the head pipe 4a. The left main frame 4bL is located on a left side of the head pipe 4a, and the right main frame 4bR is located on a right side of the head pipe 4a. For example, the main frames 4bL and 4bR are symmetrical in the left-right direction. The left main frame 4bL is an example of a left frame and an upper left frame, and the right main frame 4bR is an example of a right frame and an upper right frame.

The down frames 4cL and 4cR extend obliquely downward and rearward from a lower portion of the head pipe 4a at positions lower than the main frames 4bL and 4bR, respectively. The down frames 4cL and 4cR extend while facing each other in the left-right direction so as to be separated from each other in the left-right direction as being separated from the head pipe 4a. The left down frame 4cL is located on the left side of the head pipe 4a, and the right down frame 4cR is located on the right side of the head pipe 4a. For example, the down frames 4cL and 4cR are symmetrical in the left-right direction. The left down frame 4cL is an example of a left frame and a lower left frame, and the right down frame 4cR is an example of a right frame and a lower right frame.

The lower frames 4dL and 4dR extend downward from lower portions of the down frames 4cL and 4cR, respectively, and then curve and extend rearward. For example, the lower frames 4dL and 4dR extend while facing each other in the left-right direction and are symmetrical in the left-right direction.

The pivot frame 4e connects rear portions of the main frames 4bL and 4bR to rear portions of the lower frames 4dL and 4dR, respectively. The pivot frame 4e is pivotally connected to a front end portion of the swing arm 11 and pivotally supports the swing arm 11.

The seat frame 4f extends rearward from rear end portions of the main frames 4bL and 4bR. In the present embodiment, the seat frame 4f extends rearward from connection portions between the main frames 4bL and 4bR and the pivot frame 4e. In FIG. 1, a part of the seat frame 4f is illustrated. The seat frame 4f supports the seat 12 located above from below.

The plurality of protective frames 4g surround the battery 6 installed between the main frames 4bL and 4bR from the left and right. The plurality of protective frames 4g include a pair of first protective frames 4ga in the left-right direction, a pair of second protective frames 4gb in the left-right direction, a pair of third protective frames 4gc in the left-right direction, and a pair of fourth protective frame 4gd in the left-right direction.

The first protective frames 4ga extend rearward from the down frames 4cL and 4cR, respectively, and are connected to the seat frame 4f at rear end portions thereof. For example, the pair of first protective frames 4ga extend while facing each other in the left-right direction and are symmetrical in the left-right direction. The first protective frames 4ga intersect the main frames 4bL and 4bR, respectively, but may or may not be joined to the main frames 4bL and 4bR.

The second protective frames 4gb extend rearward from the lower frames 4dL and 4dR, respectively, and are connected to the pivot frame 4e at rear end portions thereof. For example, the pair of second protective frames 4gb extend while facing each other in the left-right direction and are symmetrical in the left-right direction. In the present embodiment, front end portions of the second protective frames 4gb are connected to the lower frames 4dL and 4dR at connection portions between the lower frames 4dL and 4dR and the down frames 4cL and 4cR, respectively. Rear end portions of the second protective frames 4gb are connected to the pivot frame 4e at the connection portions between the main frames 4bL and 4bR and the pivot frame 4e, respectively.

The third protective frames 4gc connect the down frame 4cL or 4cR to the second protective frame 4gb to form a truss structure on each of the left side and the right side of the vehicle 1. For example, the pair of third protective frames 4gc extend while facing each other in the left-right direction and are symmetrical in the left-right direction.

The fourth protective frames 4gd connect the main frame 4bL or 4bR to the second protective frame 4gb to form a truss structure on each of the left side and the right side of the vehicle 1. For example, the pair of fourth protective frames 4gd extend while facing each other in the left-right direction and are symmetrical in the left-right direction.

The electric motor 5 is disposed in a space surrounded by the vehicle body frame 4, in the present embodiment, in a space surrounded by the lower frames 4dL and 4dR, the pair of second protective frames 4gb, and the pivot frame 4e. The electric motor 5 is fixed to the pair of second protective frames 4gb and the lower frames 4dL and 4dR. The electric motor 5 may be further fixed to another frame element such as the pivot frame 4e.

The electric motor 5 rotates a drive shaft and outputs rotational power via the drive shaft. The electric motor 5 is a rotating electric machine that converts electric energy into mechanical energy. The structure of the electric motor 5 may be any existing structure. The electric motor 5 includes a motor housing 5a that forms an outer shell of the electric motor 5. For example, the electric motor 5 includes a rotor that rotates integrally with the drive shaft, a stator, and a speed reducer in the motor housing 5a. The rotational power of the drive shaft is output to the outside via the speed reducer. The electric motor 5 may have an inner rotor structure in which the rotor is located inside the stator or an outer rotor structure in which the rotor is located outside the stator.

The speed reducer of the electric motor 5 is connected to the rear wheel 3 via a power transmission member 17 such as a chain or a belt. The electric motor 5 transmits the rotational power of the drive shaft to the rear wheel 3 via the speed reducer and the power transmission member 17.

The vehicle 1 includes the pair of left and right two front forks 9. Upper portions of the pair of front forks 9 are connected to a pair of brackets 9a disposed at an interval in an upper-lower direction, and lower portions of the pair of front forks 9 rotatably support the front wheel 2. The brackets 9a are connected to the steering shaft 8 that supports the handlebars 7. The steering shaft 8 is inserted into the head pipe 4a and is supported by the head pipe 4a so as to be angularly displaceable. The vehicle 1 includes a front fender 2a fixed to the front fork 9. The front fender 2a is located above the front wheel 2 and covers the front wheel 2 at least from above.

The swing arm 11 supports the rear wheel 3, extends in a front-rear direction, and is pivotally supported at the front end portion thereof by the pivot frame 4e. The rear suspension 10 is connected to the swing arm 11 and the vehicle body frame 4.

The cover 16 is located above the electric motor 5. In the present embodiment, the position of the cover 16 corresponds to the position of a fuel tank of the motorcycle on which an internal combustion engine is mounted, and the outer shape of the cover 16 is similar to the outer shape of the fuel tank. Therefore, the rider sitting on the seat 12 can drive the vehicle 1 while supporting the body of the rider and a vehicle body by sandwiching the cover 16 between both knees.

The cover 16 is supported by one or both of the pair of first protective frames 4ga and the pair of main frames 4bL and 4bR, and is supported by the pair of main frames 4bL and 4bR in the present embodiment. The cover 16 includes an opening and closing lid 16a that moves between a closed position where the battery 6 mounted on the vehicle 1 is covered from above and an open position where the battery 6 is exposed from above. The opening and closing lid 16a pivots about a front portion or a rear portion of the opening and closing lid 16a as a fulcrum.

The seat 12 is located behind the cover 16 and on an upper portion of the seat frame 4f. The seat 12 is attachable to and detachable from the seat frame 4f. In the present embodiment, in a state where the seat 12 is attached to the seat frame 4f, a front portion of the seat 12 overlaps a rear portion of the cover 16 from above.

The battery 6 includes a high-voltage battery 6a and a low-voltage battery 6b. The rated voltage of the high-voltage battery 6a is higher than the rated voltage of the low-voltage battery 6b. The low-voltage battery 6b outputs electric power having a lower voltage than the high-voltage battery 6a. An example of the rated voltage of the high-voltage battery 6a is 24 V, and an example of the rated voltage of the low-voltage battery 6b is 12 V.

Each of the high-voltage battery 6a and the low-voltage battery 6b includes a secondary battery capable of charging and discharging the electric power. Examples of the secondary battery may include a lead storage battery, a nickel-cadmium storage battery, a nickel-hydrogen battery, a metal lithium battery, a lithium ion secondary battery, a lithium ion polymer secondary battery, a sodium-sulfur battery, a sodium ion battery, and an all-solid-state battery. The high-voltage battery 6a and the low-voltage battery 6b supply the stored electric power to electrical components that use the electric power in the vehicle 1.

In the present embodiment, the storage capacity of the high-voltage battery 6a is larger than the storage capacity of the low-voltage battery 6b. The hour rate capacity of the high-voltage battery 6a is larger than the hour rate capacity of the low-voltage battery 6b. An example of the unit of the hour rate capacity is ampere-hour (Ah). The size of the high-voltage battery 6a is also larger than the size of the low-voltage battery 6b.

The high-voltage battery 6a is connected to the electric motor 5 via the inverter 14 and supplies electric power to the electric motor 5. The electric motor 5 is one of the electrical components. The inverter 14 converts DC power supplied from the high-voltage battery 6a into AC power and outputs the AC power. The high-voltage battery 6a is connected to the low-voltage battery 6b via the converter 15, and supplies electric power to the low-voltage battery 6b. The converter 15 is a DC-DC converter that steps down the voltage of the DC power supplied from the high-voltage battery 6a to the voltage of the DC power to be supplied to the low-voltage battery 6b and outputs the stepped-down voltage. In the present embodiment, the converter 15 converts the power of the rated voltage of the high-voltage battery 6a into the power of the rated voltage of the low-voltage battery 6b. The high-voltage battery 6a is connected to a power generation device such as a regenerative brake provided in the vehicle 1, and stores electric power supplied from the power generation device.

The low-voltage battery 6b is connected to the electrical components of the vehicle 1 excluding the electric motor 5, and outputs electric power to the electrical components. Examples of the electrical components to which the low-voltage battery 6b supplies power include the ECU 13, the inverter 14, the converter 15, a meter 21, a headlight 22, a taillight 23, and direction indicators. In the present embodiment, the meter 21 is located on the handlebar 7, the headlight 22 is located in front of the head pipe 4a, and the taillight 23 is located above the rear wheel 3. The direction indicators are located at a front portion and a rear portion of the vehicle 1.

In the present embodiment, the high-voltage battery 6a is detachably disposed on the vehicle body frame 4. The high-voltage battery 6a can be replaced with another charged high-voltage battery 6a when a state of charge (SOC) representing a charging state or a charging rate decreases. Therefore, the vehicle 1 can be quickly supplied with electric power.

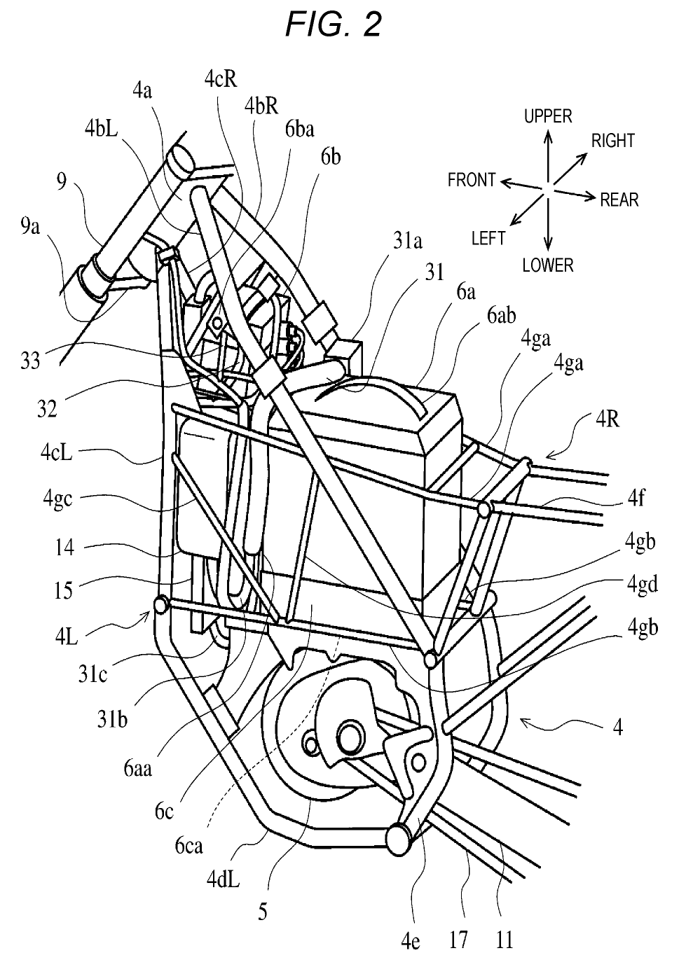

FIG. 2 is an enlarged perspective view illustrating the high-voltage battery 6a of FIG. 1 and a periphery thereof. In FIG. 2, the seat 12 and the cover 16 are removed. As illustrated in FIG. 2, a battery stand 6c is fixed to the pair of second protective frames 4gb. The battery stand 6c is located above the electric motor 5. The battery stand 6c has a shallow box shape opened upward. The high-voltage battery 6a is placed on the battery stand 6c or removed from the battery stand 6c by access from above the battery stand 6c. In the present embodiment, the high-voltage battery 6a includes a handle 6ab in an upper portion. A person can grip the handle 6ab with a hand of the person and manually place and remove the high-voltage battery 6a. The battery stand 6c surrounds a lower portion of the high-voltage battery 6a placed on the battery stand 6c from below, in the front-rear and left-right directions, and supports the lower portion of the high-voltage battery 6a from below, in the front-rear, and left-right directions.

In a state of being placed on the battery stand 6c, the high-voltage battery 6a is located above the electric motor 5. The high-voltage battery 6a is located rearward of the head pipe 4a and the down frames 4cL and 4cR. The high-voltage battery 6a is located between a left frame group 4L including the left main frame 4bL, the left down frame 4cL, and the left protective frames 4ga to 4gd and a right frame group 4R including the right main frame 4bR, the right down frame 4cR, and the right protective frames 4ga to 4gd in a top view of the vehicle 1 viewed from above. The high-voltage battery 6a is protected from the left side and the right side by the left frame group 4L and the right frame group 4R, respectively.

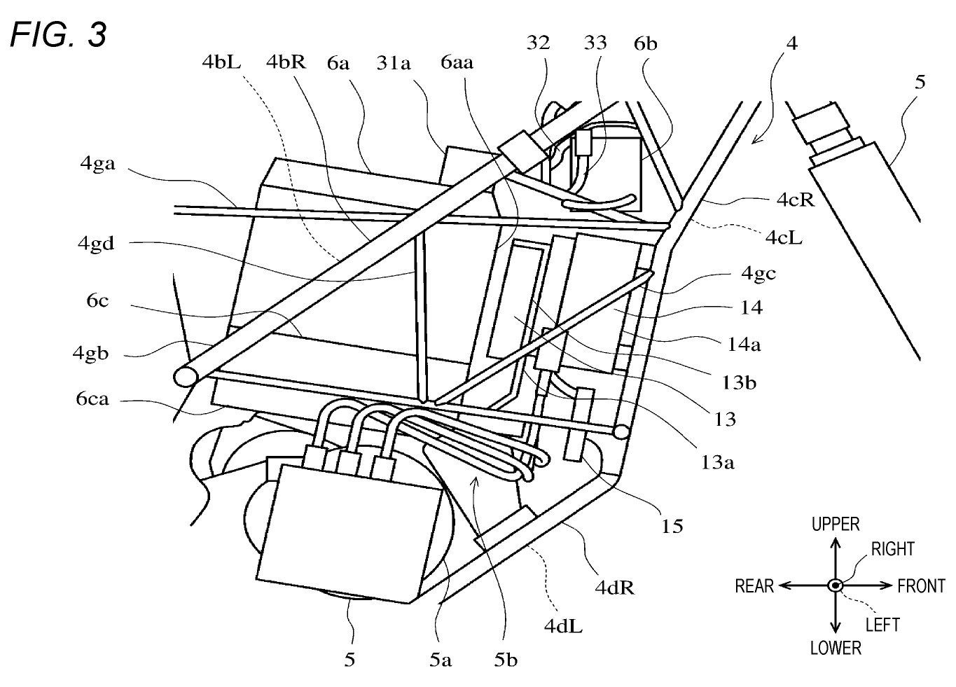

FIG. 3 is an enlarged right side view of the high-voltage battery 6a in FIG. 1 and the periphery thereof. In FIG. 3, the seat 12 and the cover 16 are removed. As illustrated in FIG. 3, the battery stand 6c is inclined such that a rear end portion of a bottom portion 6ca of the battery stand 6c is located above a front end portion of the bottom portion 6ca. Therefore, in the state where the high-voltage battery 6a is placed on the battery stand 6c, a front surface 6aa facing the front of the high-voltage battery 6a is inclined such that an upper end portion of the front surface 6aa is located forward of a lower end portion of the front surface 6aa. In the present embodiment, the front surface 6aa is inclined along the down frames 4cL and 4cR. Accordingly, a space in front of the high-voltage battery 6a in the vehicle body frame 4 can be reduced. Therefore, the vehicle body frame 4 can be made compact by efficient use of the space in the vehicle body frame 4.

As illustrated in FIGS. 2 and 3, the low-voltage battery 6b is fixed to the vehicle body frame 4. For example, the low-voltage battery 6b is fixed to either or both of the down frames 4cL and 4cR and the pair of first protective frames 4ga via a fixture 6ba such as a bracket. The low-voltage battery 6b is located forward of the high-voltage battery 6a placed on the battery stand 6c.

Further, in the top view of the vehicle 1 viewed from above, the low-voltage battery 6b is located between the head pipe 4a and the high-voltage battery 6a placed on the battery stand 6c.

The low-voltage battery 6b is located above the high-voltage battery 6a placed on the battery stand 6c. In the present embodiment, in a side view of the vehicle 1 viewed from a side, at least a part of the low-voltage battery 6b is located above an upper front end of the high-voltage battery 6a placed on the battery stand 6c. The upper front end of the high-voltage battery 6a may be the upper end portion of the front surface 6aa of the high-voltage battery 6a. In the side view of the vehicle 1 from the side, a rear end of the low-voltage battery 6b is located forward of a front end of the high-voltage battery 6a placed on the battery stand 6c. The front end of the high-voltage battery 6a may be a front end portion of the front surface 6aa of the high-voltage battery 6a. In the present embodiment, the entire low-voltage battery 6b is located forward of the high-voltage battery 6a.

The low-voltage battery 6b is located in a region between the left main frame 4bL and the left down frame 4cL and in a region between the right main frame 4bR and the right down frame 4cR in the side view of the vehicle 1. In the present embodiment, the low-voltage battery 6b is located in a region between the left main frame 4bL and the first protective frame 4ga and in a region between the right main frame 4bR and the first protective frame 4ga in the side view of the vehicle 1.

As illustrated in FIG. 2, similarly to the high-voltage battery 6a, the inverter 14 is located between the left frame group 4L and the right frame group 4R in the top view of the vehicle 1 viewed from above. The inverter 14 is protected from the left side and the right side by the left frame group 4L and the right frame group 4R.

As illustrated in FIG. 3, the inverter 14 is located forward of the high-voltage battery 6a. In the present embodiment, the inverter 14 is located between the down frames 4cR and 4cL and the high-voltage battery 6a. The inverter 14 is located lower than the lower bracket 9a of the pair of brackets 9a of the front fork 9. At least a portion of the inverter 14 is located lower than the front fender 2a illustrated in FIG. 1. In the present embodiment, a portion of the inverter 14 is located lower than an upper end of the front fender 2a.

The inverter 14 is fixed to the down frames 4cR and 4cL via a fixture such as a bracket. A front surface 14a of the inverter 14 facing forward is inclined such that an upper end portion of the front surface 14a is located forward of a lower end portion of the front surface 14a. In the present embodiment, the front surface 14a is inclined along the front surface 6aa of the high-voltage battery 6a and the down frames 4cL and 4cR. The inverter 14 is located lower than the low-voltage battery 6b. In the present embodiment, the inverter 14 is located below the low-voltage battery 6b. In the top view of the vehicle 1 viewed from above, at least a part of the low-voltage battery 6b overlaps the inverter 14.

The amount of heat generated by the inverter 14 may be larger than the amount of heat generated by the high-voltage battery 6a. Since the inverter 14 is located forward of the high-voltage battery 6a, the inverter 14 can be cooled by efficiently receiving traveling wind that flows into the vehicle body frame 4 from the front of the vehicle 1. Since the low-voltage battery 6b is located above the inverter 14, a thermal influence on the low-voltage battery 6b received from the inverter 14 is reduced. The inflow of the traveling wind into the inverter 14 is not hindered by the low-voltage battery 6b.

The ECU 13 is located between the high-voltage battery 6a and the inverter 14. In the present embodiment, the ECU 13 is attached to a unit base 13a fixed to the pair of second protective frames 4gb. The unit base 13a extends upward from the second protective frames 4gb. The front surface 13b of the ECU 13 facing forward is inclined such that an upper end portion of the front surface 13b is located forward of a lower end portion of the front surface 13b. In the present embodiment, the front surface 13b is inclined along the front surface 6aa of the high-voltage battery 6a, the front surface 14a of the inverter 14, and the down frames 4cL and 4cR. The ECU 13 is located lower than the low-voltage battery 6b. In the present embodiment, the ECU 13 is located at the same height as the inverter 14. Therefore, the ECU 13 is located on the back of the inverter 14.

Since the front surface 6aa of the high-voltage battery 6a, the front surface 13b of the ECU 13, and the front surface 14a of the inverter 14 extend along each other, a region occupied by the high-voltage battery 6a, the ECU 13, and the inverter 14 in a direction perpendicular to the front surface 6aa can be compact.

The converter 15 is located forward of the high-voltage battery 6a. In the present embodiment, the converter 15 is located between the high-voltage battery 6a and the down frames 4cR and 4cL. The converter 15 is fixed to the down frames 4cR and 4cL via a fixture such as a bracket. The converter 15 is located lower than the ECU 13 and the inverter 14, and is located below the inverter 14 in the present embodiment.

A motor cable 5b extends from the electric motor 5 to the inverter 14. The electric motor 5 is supplied with three-phase AC power from the inverter 14 via the motor cable 5b. In the side view of the vehicle 1, the motor cable 5b is located in a region in front of the high-voltage battery 6a, and in the present embodiment, in a region extending from the high-voltage battery 6a to the down frames 4cR and 4cL.

As illustrated in FIG. 2, in the state where the high-voltage battery 6a is placed on the battery stand 6c, a first harness 31 extends from the high-voltage battery 6a. A connector 31a at an end portion of the first harness 31 can be detachably connected to a terminal of the high-voltage battery 6a. The terminal of the high-voltage battery 6a to which the connector 31a is connected is located closer to the front than the center of the high-voltage battery 6a in the front-rear direction. When the high-voltage battery 6a is placed on the battery stand 6c, the connector 31a is connected to the terminal of the high-voltage battery 6a. When the high-voltage battery 6a is removed from the battery stand 6c, the connector 31a is removed from the terminal of the high-voltage battery 6a.

The first harness 31 includes a high-voltage side cable 31b and a low-voltage side cable 31c. The high-voltage side cable 31b is connected to the inverter 14. The low-voltage side cable 31c is connected to the converter 15. In the side view of the vehicle 1, the first harness 31 is located in a region in front of the high-voltage battery 6a, and in the present embodiment, in a region extending from the high-voltage battery 6a to the down frames 4cR and 4cL. The high-voltage side cable 31b and the low-voltage side cable 31c are located on the opposite side of the motor cable 5b with respect to the center in the vehicle width direction, which is the left-right direction of the vehicle 1.

A converter cable 32 extending from the converter 15 is connected to the terminal of the low-voltage battery 6b. In a side view of the vehicle 1, the converter cable 32 is located in a region forward of the high-voltage battery 6a, and in the present embodiment, in a region extending from the front surface 6aa of the high-voltage battery 6a to the low-voltage battery 6b.

Another terminal of the low-voltage battery 6b is connected to a second harness 33. The second harness 33 is connected to various electrical components except for the electric motor 5. Examples of the electrical components to which the second harness 33 is connected include the ECU 13, the inverter 14, the converter 15, the meter 21, the headlight 22, the taillight 23, and the direction indicators. Most of the second harness 33 excluding a portion reaching the taillight 23 and the direction indicators is located in a region forward of the high-voltage battery 6a in the side view of the vehicle 1.

As described above, most of electric wires mounted on the vehicle 1 are located in a region in front of the high-voltage battery 6a. That is, most of the electric wires mounted on the vehicle 1 are located forward of the seat 12. Therefore, the amount of electric wires extending from the front portion to the rear portion of the vehicle 1 is reduced. Therefore, the length of the electric wires connecting the electrical components, the high-voltage battery 6a, and the low-voltage battery 6b to each other can be reduced.

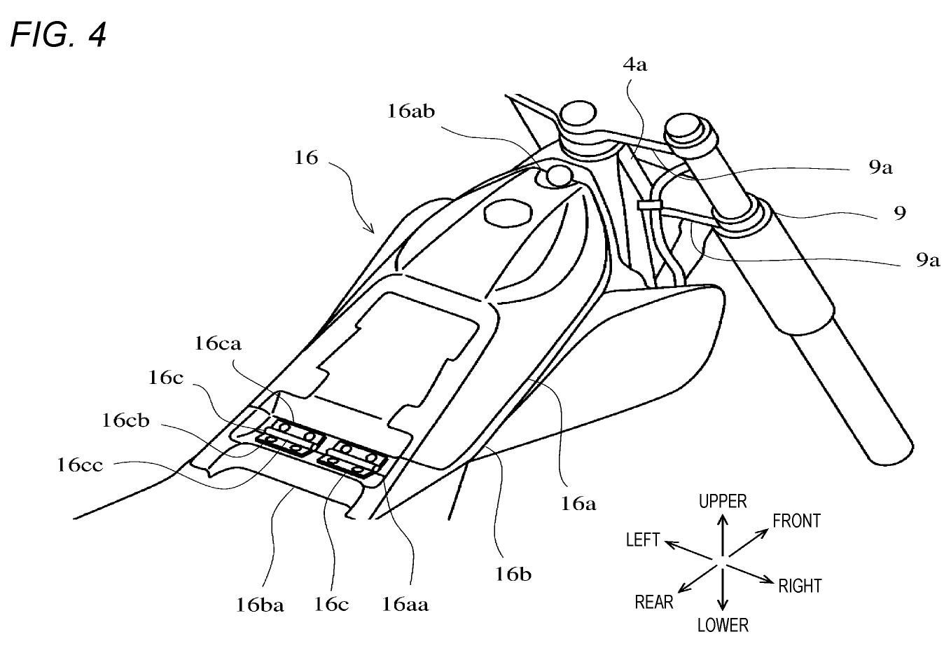

FIG. 4 is a perspective view of the cover 16 in FIG. 1 at the closed position as viewed obliquely from above. In FIG. 4, the seat 12 is removed, and a portion of the cover 16 on which the seat 12 is placed is exposed. As illustrated in FIG. 4, the cover 16 includes the opening and closing lid 16a and a base portion 16b. The base portion 16b is fixed to the vehicle body frame 4. In the present embodiment, it is fixed to the pair of first protective frames 4ga. The opening and closing lid 16a is operably connected to the base portion 16b. In the present embodiment, the opening and closing lid 16a is pivotable about a rear portion 16ba of the base portion 16b as a fulcrum, but may be pivotable about a front portion of the base portion 16b as a fulcrum.

The cover 16 includes hinges 16c connecting the rear portion 16ba of the base portion 16b to a rear portion 16aa of the opening and closing lid 16a. In the present embodiment, the cover 16 includes two hinges 16c, and each of the hinges 16c includes a first blade 16ca, a second blade 16cb, and a pin 16cc, which is a rotation shaft. The first blade 16ca and the second blade 16cb are connected by the pin 16cc, and are pivotable with respect to each other about the pin 16cc. The two hinges 16c are disposed such that an axial direction of the pins 16cc is along the left-right direction. The first blade 16ca is connected to the rear portion 16aa of the opening and closing lid 16a, and the second blade 16cb is connected to the rear portion 16ba of the base portion 16b.

The opening and closing lid 16a pivots about the rotation shaft in the left-right direction such that a front portion 16ab of the opening and closing lid 16a moves in the upper-lower direction and the front-rear direction. The opening and closing lid 16a at the closed position is moved to the open position by lifting the front portion 16ab upward at the closed position.

The seat 12 is attached to the vehicle 1 with the opening and closing lid 16a at the closed position. The seat 12 covers the hinges 16c and a part of the opening and closing lid 16a.

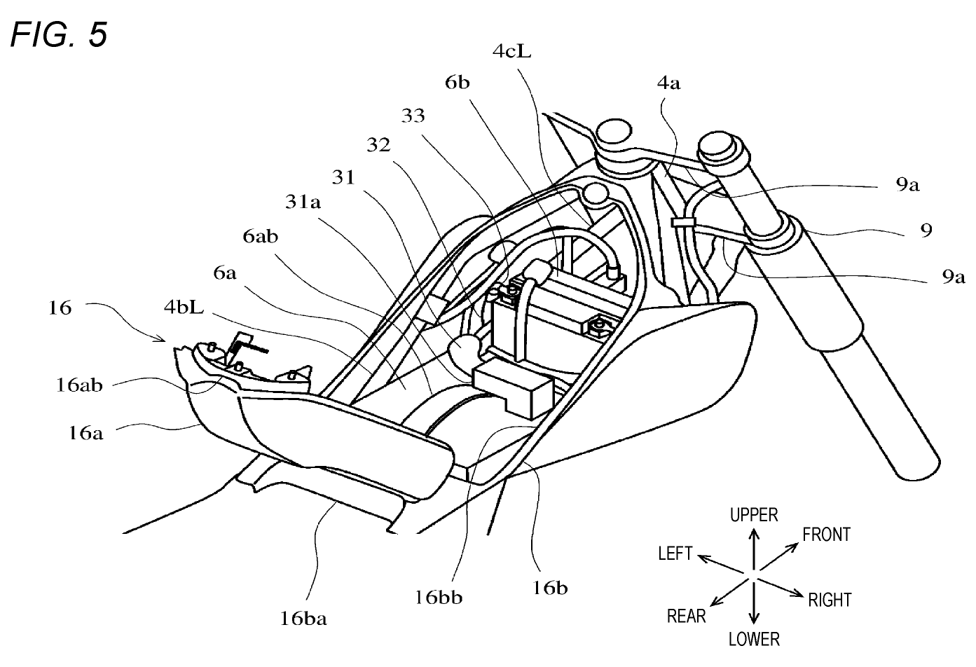

FIG. 5 is a perspective view illustrating a state in which the opening and closing lid 16a of the cover 16 in FIG. 4 is at the open position. As illustrated in FIG. 5, the base portion 16b includes an opening 16bb that opens upward. In the present embodiment, the base portion 16b extends upward from the main frames 4bL and 4bR, covers the left main frame 4bL from the left, and covers the right main frame 4bR from the right. The base portion 16b covers the low-voltage battery 6b and a part of the upper portion of the high-voltage battery 6a from the left-right direction.

The opening 16bb has a size and a shape that expose the upper portion of the high-voltage battery 6a upward. In the present embodiment, the opening 16bb has a size and a shape that expose the upper portion of the high-voltage battery 6a and an upper portion of the low-voltage battery 6b upward.

When the opening and closing lid 16a is at the open position, the high-voltage battery 6a and the low-voltage battery 6b can be accessed from above through the opening 16bb. The placement and removal of the high-voltage battery 6a with respect to the battery stand 6c can be performed by moving the high-voltage battery 6a through the opening 16bb by a hand of the person gripping the handle 6ab. The attachment and detachment of the low-voltage battery 6b can be performed by attaching and detaching the low-voltage battery 6b through the opening 16bb.

The replacement of the high-voltage battery 6a can be performed by simple work including the attachment and detachment of the seat 12, the opening and closing of the opening and closing lid 16a, and the removal and placement of the high-voltage battery 6a. The replacement of the low-voltage battery 6b can be performed by simple work including the attachment and detachment of the seat 12, the opening and closing of the opening and closing lid 16a, and the detachment and attachment of the low-voltage battery 6b.

In the top view of the vehicle 1 viewed from above, the front portion 16ab of the opening and closing lid 16a at the open position is located at the position of the hinge 16c or rearward of the position of the hinge 16c in the front-rear direction. The front surface 6aa of the high-voltage battery 6a placed on the battery stand 6c is inclined such that the upper end portion is located forward of the lower end portion. That is, the front surface 6aa is inclined such that the upper end portion thereof is located farther away from the hinges 16c in the front-rear direction than the lower end portion thereof. Therefore, the high-voltage battery 6a can be placed on and removed from the battery stand 6c by access from the side opposite to the hinge 16c and the opening and closing lid 16a, which is at the open position with respect to the opening 16bb. Therefore, interference between the high-voltage battery 6a and the opening and closing lid 16a when the high-voltage battery 6a is removed and placed is prevented.

Further, the low-voltage battery 6b is located on the side opposite to the hinges 16c with respect to the cover 16 in the top view of the vehicle 1 viewed from above. Therefore, interference between the low-voltage battery 6b and the opening and closing lid 16a when the low-voltage battery 6b is detached and attached is prevented.

Although the exemplary embodiment of the present disclosure has been described above, the present disclosure is not limited to the above embodiment. That is, various modifications and improvements can be made within the scope of the present disclosure. For example, various modifications to the embodiment and forms constructed by combining components in different embodiments are also included in the scope of the present disclosure.

For example, the vehicle 1 according to the embodiment is a motorcycle, but is not limited thereto. For example, the vehicle 1 may be a three-wheeled vehicle or a four-wheeled vehicle. In the vehicle 1, the positional relationship among the high-voltage battery 6a, the low-voltage battery 6b, and the electric motor 5 may also be similar to the positional relationship in the present disclosure. In the vehicle 1, the positional relationship between the combination of the high-voltage battery 6a, the low-voltage battery 6b, and the electric motor 5 and one or more of the ECU 13, the inverter 14, and the converter 15 may be similar to the positional relationship in the present disclosure. With the above positional relationship, effects similar to those of the present disclosure can be obtained.

The vehicle 1 according to the embodiment is an electric vehicle (EV), but is not limited thereto. For example, the vehicle 1 may be a hybrid vehicle including the electric motor 5 and the internal combustion engine. In the vehicle 1, the positional relationship among the high-voltage battery 6a, the low-voltage battery 6b, and the electric motor 5 may also be similar to the positional relationship in the present disclosure. The positional relationship between the combination of the high-voltage battery 6a, the low-voltage battery 6b, and the electric motor 5 and one or more of the ECU 13, the inverter 14, and the converter 15 may be similar to the positional relationship in the present disclosure.

In the embodiment, the opening and closing lid 16a of the cover 16 is hinged at the rear portion 16aa, but may be hinged at the front portion 16ab. In this case, the high-voltage battery 6a placed on the battery stand 6c may be inclined such that the upper end portion of the front surface 6aa is located rearward of the lower end portion. That is, the high-voltage battery 6a may be inclined such that the upper end portion of the front surface 6aa is located in a direction opposite to the hinges 16c with respect to the lower end portion.

Examples of aspects of the technology of the present disclosure will be described below. A straddle-type vehicle according to a first aspect of the present disclosure includes: a vehicle body frame including a head pipe, and a left frame and a right frame extending rearward from the head pipe and forming a pair in a left-right direction; an electric motor that is a traveling drive source; a high-voltage battery configured to output electric power to the electric motor; and a low-voltage battery configured to output electric power having a lower voltage than the high-voltage battery, in which in a top view of the straddle-type vehicle, the electric motor, the high-voltage battery, and the low-voltage battery are located between the left frame and the right frame, and the low-voltage battery is located forward of the high-voltage battery.

According to the first aspect, the electric motor, the high-voltage battery, and the low-voltage battery are protected by the left frame and the right frame. Since the low-voltage battery is located forward of the high-voltage battery, it is possible to reduce the length of electrical interconnects connecting the low-voltage battery to the high-voltage battery and simplify the electrical interconnects.

The straddle-type vehicle according to a second aspect of the present disclosure may be configured such that in the first aspect, the low-voltage battery is located between the head pipe and the high-voltage battery in the top view of the straddle-type vehicle.

According to the second aspect, the region behind the head pipe in the vehicle body frame is effectively used by the low-voltage battery. Since the low-voltage battery and the high-voltage battery do not overlap each other in the top view of the straddle-type vehicle, the low-voltage battery and the high-voltage battery can be individually attached and detached. Further, the low-voltage battery is less likely to be affected by heat generated by the high-voltage battery.

The straddle-type vehicle according to a third aspect of the present disclosure may be configured such that in the first or second aspect, the low-voltage battery is located above the high-voltage battery.

According to the third aspect, the low-voltage battery does not prevent traveling wind flowing into the vehicle body frame from the front of the straddle-type vehicle from being blown into the high-voltage battery having a high temperature.

The straddle-type vehicle according to a fourth aspect of the present disclosure may be configured such that in any one of the first to third aspects, the straddle-type vehicle further includes: an inverter configured to convert DC power output from the high-voltage battery into AC power to be supplied to the electric motor, and the inverter is located between the left frame and the right frame in the top view of the straddle-type vehicle and is located in front of the high-voltage battery.

According to the fourth aspect, the inverter is protected by the left frame and the right frame. Although the amount of heat generated by the inverter is larger than that of the high-voltage battery, since the inverter is located in front of the high-voltage battery, the inverter can be cooled by efficiently receiving traveling wind that flows into the vehicle body frame from the front of the straddle-type vehicle.

The straddle-type vehicle according to a fifth aspect of the present disclosure may be configured such that in the fourth aspect, the low-voltage battery is located above the inverter.

According to the fifth aspect, the low-voltage battery does not prevent the traveling wind flowing into the vehicle body frame from the front of the straddle-type vehicle from being blown into the inverter. The low-voltage battery is hardly affected by heat generated by the inverter. Further, when the low-voltage battery is accessed from above, the access is not hindered by the inverter.

The straddle-type vehicle according to a sixth aspect of the present disclosure may be configured such that in the fourth or fifth aspect, the straddle-type vehicle further includes: an electronic control unit configured to control an electric component provided in the straddle-type vehicle, and the electronic control unit is located between the high-voltage battery and the inverter.

According to the sixth aspect, the electronic control unit that generates heat can be cooled by the traveling wind after passing through the inverter. Since the electronic control unit is located in front of the high-voltage battery, it is possible to reduce the length of the electrical interconnects from the low-voltage battery to the electronic control unit and simplify the electrical interconnects.

The straddle-type vehicle according to a seventh aspect of the present disclosure may be configured such that in any one of the fourth to sixth aspects, the straddle-type vehicle further includes: a DC-DC converter configured to step down a voltage of DC power output from the high-voltage battery to a voltage of DC power to be supplied to the low-voltage battery, and the DC-DC converter is located forward of the high-voltage battery.

According to the seventh aspect, since the DC-DC converter is located forward of the high-voltage battery, the length of the electrical interconnects from the DC-DC converter to the low-voltage battery can be reduced, and the electrical interconnects can be simplified.

The straddle-type vehicle according to an eighth aspect of the present disclosure may be configured such that in any one of the first to seventh aspects, the vehicle body frame includes: a pair of upper frames corresponding to the left frame and the right frame and arranged in the left-right direction, respectively; and a pair of lower frames located lower than the pair of upper frames and arranged in the left-right direction, the pair of lower frames extending rearward and downward from the head pipe. In a side view of the straddle-type vehicle, the low-voltage battery is located between the pair of upper frames and the pair of lower frames.

According to the eighth aspect, the low-voltage battery is protected by the upper left frame and the upper right frame and the lower left frame and the lower right frame.

The straddle-type vehicle according to a ninth aspect of the present disclosure may be configured such that in any one of the first to eighth aspects, the straddle-type vehicle further includes a cover that moves between a closed position where the high-voltage battery mounted on the straddle-type vehicle is covered from above and an open position where the high-voltage battery is exposed from above, the high-voltage battery is replaceable from above, and the low-voltage battery is located at a position where the low-voltage battery is accessed in a state where the cover is located at the open position.

According to the ninth aspect, when the cover is moved to the open position, the high-voltage battery and the low-voltage battery can be accessed. When the cover is moved to the closed position, the high-voltage battery and the low-voltage battery are protected from above by the cover.

The straddle-type vehicle according to a tenth aspect of the present disclosure may be configured such that in the ninth aspect, the cover includes a hinge configured to move the cover between the closed position and the open position with a rear end of the cover as a fulcrum, and the high-voltage battery in a state of being mounted on the straddle-type vehicle is inclined such that an upper end of a front surface of the high-voltage battery facing forward is located forward of a lower end of the front surface.

According to the tenth aspect, when the cover is at the open position, the high-voltage battery can be easily attached and detached.

The straddle-type vehicle according to an eleventh aspect of the present disclosure may be configured such that in the ninth or tenth aspect, the cover includes a hinge configured to move the cover between the closed position and the open position with an end portion of the cover as a fulcrum, and the low-voltage battery mounted on the straddle-type vehicle is located on a side opposite to the hinge with respect to the cover in the top view of the straddle-type vehicle.

According to the eleventh aspect, the portion opposite to the hinge of the portion closed by the cover can be widely opened when the cover is at the open position. Therefore, high accessibility to the low-voltage battery is obtained, and the replacement of the low-voltage battery is facilitated.

Numbers such as ordinal numbers and quantities used in the present specification are all examples for specifically describing the technique of the present disclosure, and the present disclosure is not limited to the exemplified numbers. The connection relation between the components is exemplified for specifically describing the technique of the present disclosure, and the connection relation for implementing the functions of the present disclosure is not limited thereto.

Since the scope of the present disclosure is defined by the appended claims rather than the description of the specification so that the present disclosure can be implemented in various forms without departing from the scope of the essential features thereof, the exemplary embodiments and modifications are exemplary and not restrictive. All modifications within the claims and the scope thereof or equivalents within the claims and the scope thereof are intended to be included in the claims.

What is claimed is:

1. A straddle-type vehicle comprising:
a vehicle body frame including a head pipe, and a left frame and a right frame extending rearward from the head pipe and forming a pair in a left-right direction;
an electric motor that is a traveling drive source;
a high-voltage battery configured to output electric power to the electric motor; and
a low-voltage battery configured to output electric power having a lower voltage than the high-voltage battery, wherein
in a top view of the straddle-type vehicle, the electric motor, the high-voltage battery, and the low-voltage battery are located between the left frame and the right frame, and
the low-voltage battery is located forward of the high-voltage battery.

2. The straddle-type vehicle according to claim 1, wherein
the low-voltage battery is located between the head pipe and the high-voltage battery in the top view of the straddle-type vehicle.

3. The straddle-type vehicle according to claim 1, wherein
the low-voltage battery is located above the high-voltage battery.

4. The straddle-type vehicle according to claim 1, further comprising:
an inverter configured to convert DC power output from the high-voltage battery into AC power to be supplied to the electric motor, wherein
the inverter is located between the left frame and the right frame in the top view of the straddle-type vehicle and is located in front of the high-voltage battery.

5. The straddle-type vehicle according to claim 4, wherein
the low-voltage battery is located above the inverter.

6. The straddle-type vehicle according to claim 4, further comprising:
an electronic control unit configured to control an electric component provided in the straddle-type vehicle, wherein
the electronic control unit is located between the high-voltage battery and the inverter.

7. The straddle-type vehicle according to claim 4, further comprising:
a DC-DC converter configured to step down a voltage of DC power output from the high-voltage battery to a voltage of DC power to be supplied to the low-voltage battery, wherein
the DC-DC converter is located forward of the high-voltage battery.

8. The straddle-type vehicle according to claim 1, wherein
the vehicle body frame includes:
a pair of upper frames corresponding to the left frame and the right frame and arranged in the left-right direction, respectively; and
a pair of lower frames located lower than the pair of upper frames and arranged in the left-right direction, the pair of lower frames extending rearward and downward from the head pipe, and
in a side view of the straddle-type vehicle, the low-voltage battery is located between the pair of upper frames and the pair of lower frames.

9. The straddle-type vehicle according to claim 1, further comprising:
a cover that moves between a closed position where the high-voltage battery mounted on the straddle-type vehicle is covered from above and an open position where the high-voltage battery is exposed from above, wherein
the high-voltage battery is replaceable from above, and
the low-voltage battery is located at a position where the low-voltage battery is accessed in a state where the cover is located at the open position.

10. The straddle-type vehicle according to claim 9, wherein
the cover includes a hinge configured to move the cover between the closed position and the open position with a rear end of the cover as a fulcrum, and
the high-voltage battery in a state of being mounted on the straddle-type vehicle is inclined such that an upper end of a front surface of the high-voltage battery facing forward is located forward of a lower end of the front surface.

11. The straddle-type vehicle according to claim 9, wherein
the cover includes a hinge configured to move the cover between the closed position and the open position with an end portion of the cover as a fulcrum, and
the low-voltage battery mounted on the straddle-type vehicle is located on a side opposite to the hinge with respect to the cover in the top view of the straddle-type vehicle.
